(19) United States
(12) Patent Application Publication
(10) Pub. No.: US 2021/0235729 A1
(43) Pub. Date: Aug. 5, 2021

(54) Method For Treating The Surface Of Plant Parts

(71) Applicant: Clariant International Ltd., Muttenz (CH)

(72) Inventors: Peter BAUR, Schondorf (DE); Luciana BODELON, Frankfurt am Main (DE); Javier Campos CUEVAS, Bad Soden (DE); Stefanie WOLF, Müden / Aller (DE); Peter MANSOUR, Bodenheim (DE); John APONTE, Charlotte, NC (US)

(73) Assignee: Clariant International Ltd., Muttenz (CH)

(21) Appl. No.: 16/972,550

(22) PCT Filed: Jun. 7, 2019
(86) PCT No.: PCT/EP2019/064998

§ 371 Date: Dec. 4, 2020

(30) Foreign Application Priority Data
Jun. 7, 2018 (DE) 10 2018 209 088.2

(51) Int. Cl. A23L 3/3517; A23L 3/358; A23L 3/3544; A23B 7/154; A23B 7/157; A23L 3/3472

(52) U.S. Cl. CPC A23L 3/3517; A23L 3/358; A23L 3/3544; A23V 2002/00; A23B 7/157; A23L 3/3472; A23B 7/154

(57) ABSTRACT

A method for masking corking on the surface of polyphenol-containing plant parts is characterized by contacting the surface of the polyphenol-containing plant parts with one or more iron(III) salts, preferably with an aqueous solution that contains one or more iron(II) salts.

The invention relates to a method of masking corky tissue on the surface of plant parts, to the use of particular reagents in this method, and to plant parts treated in accordance with the invention.

The occurrence of spots, especially of corky tissue, on the surface of fruits, fruit tubers or other plant parts, for example as a reaction to minor injuries, as a result of pest infestation, physiological factors such as significant growth, weather events such as hail or damage in the course of harvesting, is a major problem for the producers of such products because such spots are perceived by the consumer as an indication of low quality of the products. Such products can therefore be sold only at significantly lower prices and, rather than for direct consumption, for example as peeled or unpeeled table fruit, are sent to industrial processing. This leads to considerable economic losses. In retail, corky fruits continue to be left on the shelf and are destroyed. From an environmental and sustainability point of view, the destruction of products that have been laboriously produced and are intrinsically of impeccable quality is undesirable.

It has now been found that corky tissue on the surface of polyphenolic plant parts can be masked in a simple manner by treating the surface of the plant parts with an aqueous solution of iron(II) salt, especially iron(II) gluconate.

The invention therefore provides a method of masking corky tissue on the surface of polyphenolic plant parts, wherein the surface of the polyphenolic plant parts is contacted with one or more iron(II) salts, preferably an aqueous solution containing one or more iron(II) salts, especially iron(II) gluconate.

The invention further provides for the use of one or more iron(II) salts, preferably of an aqueous solution containing one or more iron(II) salts, especially iron(II) gluconate, and of the preferred embodiments described hereinafter, for masking of corky tissue on the surface of polyphenolic plant parts.

The invention likewise provides polyphenolic plant parts, the surface of which contains sections of corky tissue, that have been masked, i.e. colored, in accordance with the invention with one or more iron(II) salts, preferably with an aqueous solution of an iron(II) salt, especially iron(II) gluconate.

The use of iron(II) gluconate for blackening of olives is already known (see, for example, U.S. Pat. No. 4,664,926). The fruit flesh of the olives is blackened here by alkaline oxidation at elevated temperature and subsequent treatment with an iron(II) gluconate solution. It cannot be inferred therefrom that iron(II) gluconate is suitable for masking of corky tissue on the surface of polyphenolic plant parts.

Fruits treated by the method of the invention give a visually faultless impression, which means that the producer or trader will have less waste and will possibly be able to achieve higher prices.

Suitable for use in the method of the invention are plant parts such as fruits, shoot tubers, root tubers, stems, leaves and/or blossoms, preferably fruits, shoot tubers and root tubers, especially fruits. According to the invention, fruits are plant organs that originated from blossom and are edible on maturity, but which are treated by the method of the invention over a prolonged period before and after harvesting.

Suitable plants are preferably fruit plants including fruits and vegetable fruits, and also ornamentals with fruits, and vegetable plants and ornamental plants with corky sites. Suitable with preference for commercial use in which appropriate plant parts, for example fruits, of as faultless an appearance as possible are to be achieved are plants in which the appropriate plant parts in the natural state have a dark, especially dark green or violet, to black color. What is preferably meant by “dark” is all colors of the fruit surface that do not have coloring in the typical fruit colors of red or bright red, orange, salmon-colored, yellow, light green or even white. The preference for dark plant parts is not for technical but for esthetic reasons since, in the case of such plant parts, the color contrast between the natural surface and the masked cork tissue is particularly small.

Preference is therefore given, for example, to the fruits of avocado varieties with dark, green to black skin, for example the Hass variety, and varieties that have been derived or further developed therefrom by growers, such as Mendez, Carmen, Lamb Hass, GEM, Puebla, Fuerte, Pinkerton, Reed, Bacon, Zutano, Gwen, and others such as Fuentes or Avocadito.

Further preferred vegetable fruits are eggplants, black radish, black celery, black potatoes such as Shetland Black or Peruvian black potatoes, black to violet corn, and dark-leaved salad varieties such as radicchio or oak leaf lettuce.

Suitable fruits are, for example, plums, figs, black cherries, blackcurrants, passionfruit, tamarillos, blackberries and/or bilberries.

Preference is given to plant parts selected from the group consisting of the fruits of avocados, eggplants, black cherries, figs and blackcurrants, preferably avocados.

Particular preference is given in accordance with the invention to avocados, very particularly at the maturity stage of dark green to black-shelled avocados, especially of the abovementioned varieties.

Polyphenolic plant parts, for example fruits, are suitable for performance of the method of the invention, i.e. especially plant parts, for example fruits, having a high proportion of hydrolyzable or condensed plant polyphenols, especially tannins.

The corky tissue colored in accordance with the invention is secondary plant dermal tissue composed of layers of gas-filled plant cells that have died in the differentiated state, and which form as a result of layering (accrustation) of the biopolymer suberin and frequently also contain plant tannins. Corky tissue (wound cork) forms, for example, in the case of injuries to the plant surface resulting from abiotic or biotic effects. The corky tissue treated in accordance with the invention on the surface of plant parts is thus dead tissue that has been exposed to the air.

The method of the invention may in principle be performed with all possible iron(II) salts, for example with Fe(II) gluconate, Fe(II) citrate, Fe(II) lactate, Fe(II) glycinate, Fe(II) salicylate, FeSO₄, FeCl₂, Fe(II) ascorbate, Fe(II) fumarate, Fe(II) bisglycinate, Fe(II) phosphate, Fe(II) succinate and/or Fe(II) tartrate. Preference is given to Fe(II) gluconate, Fe(II) citrate, Fe(II) lactate, Fe(II) glycinate, Fe(II) salicylate, FeSO₄ and/or FeCl₂. The iron(II) salts, especially those mentioned above, may possibly be present as different hydrates. Particular preference is given to iron(II) salts approved for treatment of foods, such as Fe(II) gluconate, Fe(II) lactate and Fe(II) citrate. Especially preferred is Fe(II) gluconate.

In one embodiment of the invention, the Fe(II) compounds may be applied not only as a solution but also in solid form and here preferably in the form of micronized salts. Micronized salts preferably have grain sizes in the range from 2 μm to 200 μm. Such salts are commercially available, for example, from Dr. Paul Lohmann GmbH KG, Emmenthal, Germany.

It is possible to use one or more iron(II) salts; preference is given to the use of one (1) iron(II) salt.

The concentration of Fe(II) in the aqueous solution used in accordance with the invention is generally 0.01 to 10 g/l, preferably 0.05 to 5 g/l, especially 0.1 to 2 g/l. For Fe(II) gluconate, this corresponds roughly to salt concentrations of 0.08 to 80 g/l, preferably 0.4 to 40 g/l, especially 0.5 to 15 g/l.

The solution of the invention comprising an iron(II) salt generally has a pH of 2.5 to 9, preferably of 3.5 to 8, more preferably of 5 to 8, especially of 6 to 7.5.

As well as one or more iron(II) salts, the solution of the invention, in a preferred embodiment, contains one or more (preferably 1) iron(III) salt(s).

Examples of such iron(III) salts are FeCl₃ or iron(III) citrate.

If the solution of the invention contains iron(III) salts, these are preferably used in concentrations of 10 to 500 mg/l (Fe(III)), more preferably 50 to 200 mg/l (Fe(III)). It is also possible to use mixed iron(II)/(III) salts.

A further source of iron(III) used may be vinasse, for example from the production of biodiesel.

Examples of such vinasse products and their composition are:

| | N | P | K | Ca | Mg | Fe | | Mn | | Cu | | Zn | |
|---|---|---|---|---|---|---|---|---|---|---|---|---|---|
| Vinasse 1 | 3.08% | 0.38% | 9.09% | 1.43% | 0.047% | 265 | mg/liter | 29.2 | mg/liter | 6.83 | mg/liter | 9.49 | mg/liter |
| Vinasse 2 | 3.08% | 0.28% | 3.91% | <0.04% | 0.19% | 12.8 | mg/kg | 24 | mg/kg | <0.431 | mg/kg | <0.862 | mg/kg |

In a further preferred embodiment of the method of the invention, plant tannins are added to the inventive solution of the iron(II) salt, preferably monomeric, oligomeric or polymeric gallic acid. This can also be effected, for example, by the addition of natural substances such as tea, for example black or green tea varieties, fruit juices such as juices of red wine grapes or red wines.

In a further preferred embodiment of the method of the invention, the plant parts, as well as the treatment with iron(II) salt(s), preferably an aqueous solution containing one or more iron(II) salts, are treated separately with plant tannins, preferably an aqueous solution of plant tannins, for example in the form of tea, for example black or green tea varieties, fruit juices such as juices of red wine grapes or red wines.

The separate application of tannins can be effected before or after the inventive application of one or more iron(II) salts, preferably an aqueous solution of iron(II) salt(s), for example immediately thereafter or else with a time delay of up to a few months, preferably 1 minute up to 90 days, for example Fe(II) in the field and the plant tannins after harvesting, for example at the supermarket. This separate application is elucidated in detail by way of example further down.

The solution of the invention may additionally contain further customary auxiliaries and additives, for example wetting agents, film formers, detergents, biocides, fertilizers, waxes and/or formulation additives, as set out by way of example further down.

The method of the invention is preferably performed at room temperature, i.e. within a temperature range from 5 to 30° C.

Preference is further given to the performance of the method of the invention at atmospheric pressure, i.e. without the use of elevated pressure.

In the method of the invention, when the aqueous solution of the invention is used, the treated plant parts, for example fruits, according to the manner of application, are contacted with the majority of the solution of the invention generally for a period of a few seconds to a few hours. Since the duration of spray application depends on the time taken for the spray liquid to dry, this generally varies between 0.5 minute and 2 hours. The time depends upon factors including the amount of water, the weather conditions and the presence of other formulation constituents such as wetting agents, humectants, fertilizers or complexing agents. In each case, in the contacting with the solution of the invention, an amount of the solution of the invention and of the reactive constituents thereof that is sufficient for the reaction is deposited on the plant parts, such that sufficient masking is possible.

It is a feature of the method of the invention that only the surface, but not the interior, of the plant parts, for example the fruit flesh, is contacted with the iron(II) salt, preferably the solution of the invention.

What is meant in accordance with the invention by “masking” is the coloring of the corky tissue, but also includes possible wetting, film formation and/or preservation of the corresponding corky tissue.

Without imposing any kind of restriction thereby, it is suspected that the inventive masking of the corky tissue on the surface of plant parts is effected by the formation of colored iron(III)-phenol complexes, for example iron gall inks. These iron-phenol dyes form, after oxidation of iron(II) in the iron(II) salt of the invention to iron(III) (for example by atmospheric oxygen), by reaction with phenols and polyphenols, especially plant tannins in the corky tissue of the fruits treated, wherein the iron(III) forms dark-colored complexes with polyphenol compounds.

In a preferred embodiment, the method of the invention is used for treatment of harvested plant parts.

The application of iron(II) salts, preferably of the solution of the invention, in this case is preferably effected by spray application or dipping of the fruits to be treated into the solution of the invention. In a further preferred embodiment of the method of the invention, the plant parts to be treated are contacted with a fabric, especially textile fabric, for example cloths, soaked with the solution of the invention. This can be effected, for example, in the course of transport of the plant parts over correspondingly configured belts. As well as the solution of the invention, the fabric used for the treatment may contain further constituents, for example oils, that contribute to cleaning, preservation and improvement of the texture. Also in the case of employment of the method of the invention by spray application or dipping in the course of cleaning and/or disinfection of the corresponding plant parts prior to packing, it is also possible to use the method, especially in the case of presence of suitable additives in the solution of the invention, for boosting of the cleaning action, preservation and texture improvement.

In order to accelerate oxidation of iron(II) to iron(III), in a preferred embodiment, air is passed through the solution of iron(II) salt during the performance of the method of the invention.

In a preferred embodiment, the plant parts are subjected to a pre-treatment step prior to the treatment with the solution of the invention. This involves surface treatment for roughening of the surface, for example by sandblasting, sandpaper and/or laser.

In a further preferred embodiment, the method of the invention is used for treatment of plant parts prior to harvesting. In this case, it is preferable to perform the method of the invention at the final application of crop protection products within the application regime prior to harvesting, for example about one month prior to harvesting. In the case of application prior to harvesting, preference is given to the spray application of the solution of the invention, which can typically be performed from the ground or from the air, in the latter case, for example, also with the aid of drones. When drones are used, by visual detection, it may also be possible to selectively treat the corky tissue on the surface of the plant parts.

In the case of performance of the method of the invention prior to harvesting, the solution of the invention may also contain further auxiliaries that are customary in the crop protection sector. Since some of these are insoluble in water, the inventive aqueous solution of an iron(II) salt may also be used in the form of a dispersion.

Examples of customary auxiliaries that may be used in the solution of the invention are preservatives, wetting agents, defoamers, functional polymers or customary, additives (dispersants, solvents) adjuvants.

Preservatives used may, for example, be organic acids and esters thereof, for example ascorbic acid, ascorbyl palmitate, sorbate, benzoic acid, methyl and propyl 4-hydroxybenzoate, propionate, phenols, for example 2-phenylphenate, 1,2-benzisothiazolin-3-one, formaldehyde, sulfurous acid and salts thereof, the addition being chosen such that the above-specified preferred pH values are observed.

The wetting agents may generally be any nonionic, amphoteric, cationic or anionic surfactants that are compatible with the composition.

Examples of nonionic surfactants are ethoxylates and alkoxylates of relatively long-chain aliphatic or aromatic alcohols, optionally in methyl end-capped form, (optionally ethoxylated) sorbitan esters, alkyl glucamides, alkyl polyglycosides, ester alkoxylates, for example ethoxylates, including with alkylated end groups. Suitable amphoteric surfactants include long-chain alkyl dimethyl betaines; among the anionic surfactants, for example, ether sulfates of ethoxylated fatty alcohols, reaction products of (optionally ethoxylated) long-chain alcohols with phosphoric acid derivatives are suitable. “Long-chain” is understood to mean linear or branched hydrocarbon chains having at least 6 and at most 22 carbon atoms.

Preferred wetting agents are those that are used as technical auxiliaries in food production, for example polysorbates such as polysorbate 20, 40, 60, 65 or 80, and phospholipids, for example lecithin, monoglycerides, polyglycerol esters, ethoxylated castor oil, EO/PO block copolymer sulfates, for example Synergen® PFA, or alkyl ether sulfates such as Genapol® LRO from Clariant, and/or glucamides.

Suitable defoamers are preferably fatty acid alkyl ester alkoxylates, organopolysiloxanes such as polydimethylsiloxanes and mixtures thereof with microfine, optionally silanized silica; perfluoroalkylphosphonates and -phosphinates, paraffins, waxes and microcrystalline waxes, and mixtures thereof with silanized silica. Also advantageous are mixtures of various foam inhibitors, for example those of silicone oil, paraffin oil and/or waxes.

The functional polymers which may be present in the solution of the invention are high molecular weight compounds of synthetic or natural origin having a molar mass of greater than 10 000. The functional polymers may act, for example, as anti-drift agents or increase rain resistance and anti-transpiration.

In a further preferred embodiment, the solution of the invention contains one or more further adjuvants as known to be usable in aqueous agrochemical compositions.

These are preferably sugar surfactants, alkyl betaines or amidoalkyl betaines, vegetable oils and derivatives thereof, amido alkylamine oxides, alkyl polyglycosides or copolymers of glycerol, coconut fatty acid and phthalic acid, ester ethoxylates or alkoxylates, including with alkylated end groups, and/or glucamides (e.g. Synergen® GA from Clariant).

It is optionally possible for solutions of the invention for applications prior to harvesting also to contain one or more insecticides and/or fungicides, if it is permissible to use them in the interval prior to harvesting.

Examples of such insecticides are imidacloprid, spinosad, permethrin, abamectin, deltamethrin, lambda-cyhalothrin, bifenthrin, dimethoate, malathion, chlorantraniliprole, thiametoxan, spirodiclofen, avermectin and etoxazole. Examples of fungicides are chlorothalonil, difeconazole, benomyl, copper oxychloride, copper hydroxide, carbendazim, ciproconazole, flusilazole, tebuconazole, iprodione, thiabendazole and copper sulfate.

The solutions of the invention are preferably deployed onto the plants or plant parts in the form of spray liquors. The spray liquors are produced by diluting concentrates with a defined amount of water. The above-specified preferred concentrations of Fe(II) are also applicable to the spray liquor.

The inventive embodiment of the invention in which, as well as the treatment with iron(II) salts (A), a separate treatment with plant tannins (B) takes place can preferably be effected as follows:

Both sequences (first A then B or, conversely, first B then A) are possible, for example
on the same day (A or B) in the cooling unit before loading of the consignment and then (B or A) on loading or cleaning with brush rolls or cloths or prior to packing in boxes
on the same day on loading of the consignment (A or B) and then (B or A) on cleaning with brush rolls or cloths or prior to packing in boxes
first in the field on the day of harvesting or up to 3 weeks before (A or B) and then (B or A) on loading of the consignment or on cleaning with brush rolls or cloths or prior to packing in boxes
in the field on the day of harvesting or up to 3 weeks before or on loading of the consignment or on cleaning with brush rolls or cloths or prior to packing in boxes (A or B) and then (B or A) only on delivery to the trader/supermarket.

### WORKING EXAMPLES

The invention is further illustrated to the person skilled in the art hereinafter by examples, but these should in no way be considered as a restriction to the embodiments detailed.

### Example 1 Masking of Red-Brown Corky Tissue in Commercially Supplied Avocado Fruits

Commercial avocado fruits of the Hass variety were purchased from a food supplier and made up with a solution of iron(II) gluconate without further additions in tap water. The fruits had the usual black color indicating maturity and taste, and slight (1-2 mm) impressibility. Application was effected outdoors at an air temperature of 18° and 63% humidity in the sun. The fruits were placed in the shade about 10 min after application. The use concentration of iron(II) gluconate was 1 g/l of salt, and about 10 μl of droplets were applied. The test solution was applied with complete coverage of corky areas in some cases, and with only half coverage of these in other cases. The test solution dried out after about 20-30 min. Only about 2 hours after application, the red-brown, corky sites were completely black and were barely distinguishable, if at all, to the naked eye from the rest of the dark shell. The texture of the corky site changed to such a degree that the rough structure of the cork became similarly smooth and shiny to the intact, healthy surface. The black color achieved was completely water-insoluble/water-resistant and could not be wiped off.

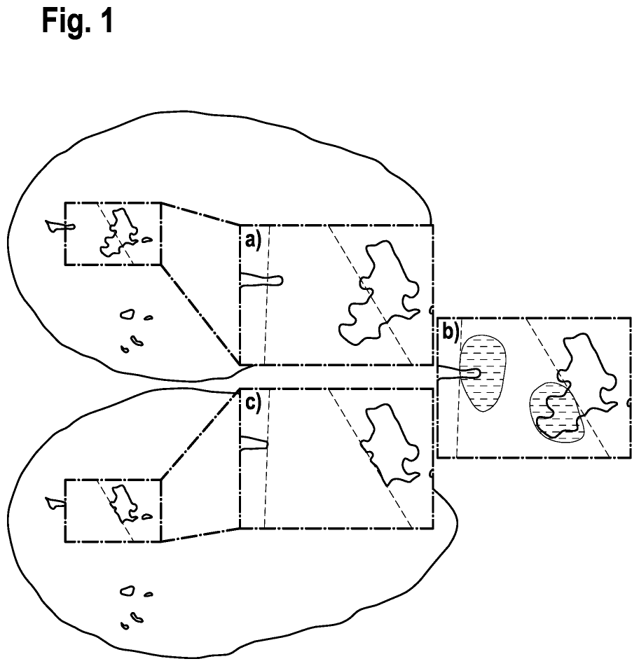

FIG. 1 shows, in schematic form, the fruit with the corky area before treatment and after about 4 hours:

Top: Fruit before application with corky sites before treatment. Individual droplets were applied in the circled region.

Bottom: Fruit 4 hours after application.

The three insets show enlargements of the treatment site before a), during b) and after application c).

### Example 2 Masking of Corky Tissue Under Various Conditions

The abovementioned treatment with iron gluconate was varied, and in all cases the masking shown in example 1 was obtained. This includes:

A) Various types of water, including deionized water, tap water, and CIPAC C standard water (with hardness 500 ppm),
B) Freshly made-up and one-week-old treatment fluid (spray liquor),
C) Treatment and/or drying or storage exposed to the sun or in the dark (box),
D) The use concentration of the iron gluconate solution. The color intensity is independent of the color of the starting solution (clear and transparent to pale yellow to yellow-brown over and above 10 g/l). In the case of avocado, a concentration of 0.5 g/l of salt was needed for the dark color shown in example 1.

### Comparative Example

Other Gluconates

Sodium gluconate and zinc gluconate had no effect and caused no change in the corky areas.

### Example 3 Other Iron(II) Salts

The following were likewise effective as masking agents, in decreasing order: iron(II) lactate, iron(III) sulfate, iron(III) citrate, iron(III) salicylate, a mixed salt of iron(II) gluconate and nitrate.

The effect of iron(II) gluconate was the strongest in terms of color and change in texture (smoothing).

### Example 4 Green Fruits and Areas without Corking

Iron(II) gluconate was applied at 5 g/l to various fruits such as apples, avocados, bananas, papayas, grapes or else avocado or apple leaves, and no change in color or any other symptoms of phytotoxicity were observed.

### Example 5 Other Fruits with Desirable Color Change Via an Appropriate Concentration of Iron(II) Gluconate are Eggplants, Cherries and Plums

1. A method of masking corky tissue on a surface of polyphenolic plant parts, wherein the surface of the polyphenolic plant parts is contacted with one or more iron(II) salts.

2. The method as claimed in claim 1, wherein the surface of the polyphenolic plant parts is contacted with an aqueous solution containing one or more iron(II) salts.

3. The method as claimed in claim 1, wherein the plant parts are selected from the group consisting of the fruits of avocados, eggplants, black cherries, figs and blackcurrants.

4. The method as claimed in claim 1, wherein the plant parts are fruits of avocados, selected from the group consisting of Hass, Mendez, Carmen, Lamb Hass, GEM, Puebla, Fuerte, Pinkerton, Reed, Bacon, Zutano, Gwen, Fuentes and Avocadito varieties.

5. The method as claimed in claim 1, wherein the iron(II) salt is selected from the group consisting of Fe(II) gluconate, Fe(II) citrate, Fe(II) lactate, Fe(II) glycinate, Fe(II) salicylate, Fe(II) ascorbate, Fe(II) fumarate, Fe(II) bisglycinate, Fe(II) phosphate, Fe(II) succinate and Fe(II) tartrate.

6. The method as claimed in claim 2, wherein an aqueous solution is used and the iron(II) concentration is 0.01 to 10 g/l.

7. The method as claimed in claim 2, wherein an aqueous solution is used and the pH of the solution is in the range from 2.5 to 9.

8. The method as claimed in claim 1, wherein an aqueous solution is used and the solution additionally contains one or more iron(III) salts.

9. The method as claimed in claim 8, wherein the additional iron(III) salt(s) come from vinasse.

10. The method as claimed in claim 2, wherein an aqueous solution is used and the solution additionally contains plant tannins.

11. The method as claimed in claim 2, wherein an aqueous solution is used and the solution additionally also contains one or more wetting agents.

12. The method as claimed in claim 3, wherein it is performed with harvested fruits.

13. The method as claimed in claim 12, wherein the plant parts, prior to the treatment are subjected to a pre-treatment step, wherein a surface treatment is effected for roughening of the surface.

14. The method as claimed in claim 1, wherein it is performed prior to the harvesting of the plant parts.

15. The method as claimed in claim 1, wherein the plant parts are additionally treated with plant tannins separately from the treatment with iron(II) salt(s), where this treatment can be effected before, during or after the treatment with iron(II) salt(s).

16. (canceled)

17. A polyphenolic plant part containing corky tissue on its surface that has been masked with one or more iron(II) salts.

18. A polyphenolic plant part containing corky tissue on its surface that has been masked with one or more aqueous solutions containing one or more iron(II) salts.
